(19) United States
(12) Patent Application Publication
(10) Pub. No.: US 2006/0209623 A1
(43) Pub. Date: Sep. 21, 2006

(54) Process and an apparatus for the production of articles from reactive components

(76) Inventors: Helmut Duschanek, Konigswinter (DE); Gerd Salah, Hennef (DE); Jurgen Wirth, Koln (DE)

Correspondence Address: BAYER MATERIAL SCIENCE LLC, 100 BAYER ROAD, PITTSBURGH, PA, 15205, US

(21) Appl. No.: 11/375,949

(22) Filed: Mar. 15, 2006

(30) Foreign Application Priority Data
Mar. 19, 2005 (DE) 102005012795.9

(51) Int. Cl. B29B 7/76

(52) U.S. Cl. 366/159.1; 366/160.4

(57) ABSTRACT

Articles, particularly, molded articles are produced from reactive components with an apparatus which includes storage vessels for the reactive components, a mixer for mixing the reactive components, dispensing units and lines for dispensing the reactive components from the storage vessels into the mixer. An important feature of this apparatus is the use of one or more dispensing units which is a piston dispensing unit that includes a dispensing piston and a spindle unit. The spindle unit includes a spindle and a spindle nut which spindle nut is driven by a torque motor.

### BACKGROUND OF THE INVENTION

The present invention relates to a process and to an apparatus for the production of articles particularly molded articles, from reactive resins, in particular from polyurethanes, in which at least one of the reactive components is dispensed with at least one piston dispensing unit containing a spindle unit driven by a torque motor.

When producing moldings from reactive resin, for example from polyurethane, it is conventional also to incorporate fillers into the reactive components. This is primarily done in order to improve the physical properties of the moldings. Thus, for example, barytes are incorporated into moldings used for acoustic insulation purposes. Ground glass fibers or ground mineral fibers are added to car bumpers in order to adapt the coefficient of thermal expansion to that of metals. Natural fibers, such as for example jute or hemp, are used ever more frequently in order, for example, to increase the rigidity of large-area moldings.

As a rule, when producing moldings from polyurethanes, the fillers are added to the polyol component because this is normally of a higher viscosity, such that the fillers do not settle out, thereby facilitating homogenization.

The use of fillers has given rise to the development of piston dispensing units. Due to their relatively low piston speed in comparison with fast-running piston pumps, these suffer substantially reduced problems associated with wear. As a result of the abrasiveness of most fillers, fast-running piston pumps are in fact unsuitable for processing filled raw materials systems because such pumps wear out within a very short time.

One substantial aspect in the development of piston dispensing units was and remains the drive system.

Since, even with the best possible homogenization, occasional agglomerates are unavoidable when using fillers, and these agglomerates result in pressure fluctuations in the nozzles in conventional high pressure mixing, it is absolutely essential to use incompressible drive components.

If the speed of a dispensing piston were to fall due to an increase in pressure, then the corresponding discharged amount would also drop, giving rise to an incorrect mixing ratio of the reactive components and to a decrease in the weight and in the specific density of the resultant molding. This would reduce the quality of the molding or even result in scrapping the molding.

It is thus absolutely essential to provide drive systems for the piston dispensing units which ensure a consistent piston dispensing speed even in the event of pressure fluctuations.

The first negative experiences in this connection were encountered when, at the outset of development of piston dispensing units, the attempt was made to equip them with simple hydraulic drives. The pressure dependency of the hydraulic pumps used was quickly recognized and the attempt was then made to improve the hydraulic systems in this respect.

One example which is particularly deserving of mention in this connection is the development of the Rimdomat technology (See brochure 32 from Hennecke GmbH, Sankt Augustin-Birlinghoven). This development was based on the linear amplifier technology described in EP-A-0 003 563. Each dispensing piston is associated with a special hydraulic piston or linear amplifier with a stepping motor. A predefined succession of pulses from a frequency generator is converted into a positional movement of the hydraulic piston driving the dispensing piston.

While the electrohydraulic piston stroke control of linear amplifier technology does indeed provide compressionally rigid drive systems, it is elaborate and complex and thus also costly.

There was accordingly a requirement to find a drive system which is not only compressionally rigid, but also simple and thus low in cost.

### SUMMARY OF THE INVENTION

The object of the present invention is to provide a simple and economic process and a corresponding apparatus for the production of moldings from reactive resins, in particular from polyurethanes, which ensures accurate dispensing even when reactive components containing fillers are used.

This and other objects which will be apparent to those skilled in the art are accomplished by using a piston dispensing unit driven by a torque motor.

### BRIEF DESCRIPTION OF THE DRAWINGS

FIG. 1 is a schematic diagram of the apparatus according to the invention as a “shot” device.

FIG. 2 is a schematic diagram of the apparatus according to the invention as a “continuous” device in the steady-state phase in which a first piston dispenser is in suction operation and a second piston dispenser is in pressure operation.

FIG. 3 shows the same apparatus as that of FIG. 2 during the non-steady-state phase Δt (See also FIG. 4.).

FIG. 4 shows a functional graph of the apparatus according to the invention operated as a “continuous” device such as that illustrated in FIGS. 2 and 3.

### DETAILED DESCRIPTION OF THE INVENTION

The present invention relates to an apparatus for the production of moldings from reactive resins comprising storage vessels for the reactive components, a mixer for mixing the reactive components, dispensing units and lines for dispensing the reactive components from the storage vessels into the mixer. An important feature of the present invention is that at least one of the dispensing units is a piston dispensing unit which includes a dispensing piston and a spindle unit with a spindle and spindle nut assigned to the dispensing piston which spindle nut is driven by a torque motor.

The invention also relates to a process for the production of moldings from reactive resins in the apparatus according to the invention, in which the reactive components are dispensed into the mixer and mixed therein to yield a reactive mixture, and the reactive mixture is then discharged from the mixer into a mold or onto a substrate, where it cures.

Polyurethane moldings made from at least one isocyanate component and at least one polyol component are preferably produced by the process according to the invention and in the apparatus according to the invention.

At least one of the reactive components preferably includes a filler. Preferred fillers include glass fibers, mineral fibers, mineral powders such as barium sulfate, pulverized plastics such as melamine resin and solid flame retardants. The dispensing units used for dispensing the reactive components with a filler are preferably piston dispensing units which contain a dispensing piston and spindle unit with a spindle and a spindle nut assigned to the dispensing piston, the spindle nut being driven by a torque motor. Piston dispensing units may, however, also be used for all of the reactive components.

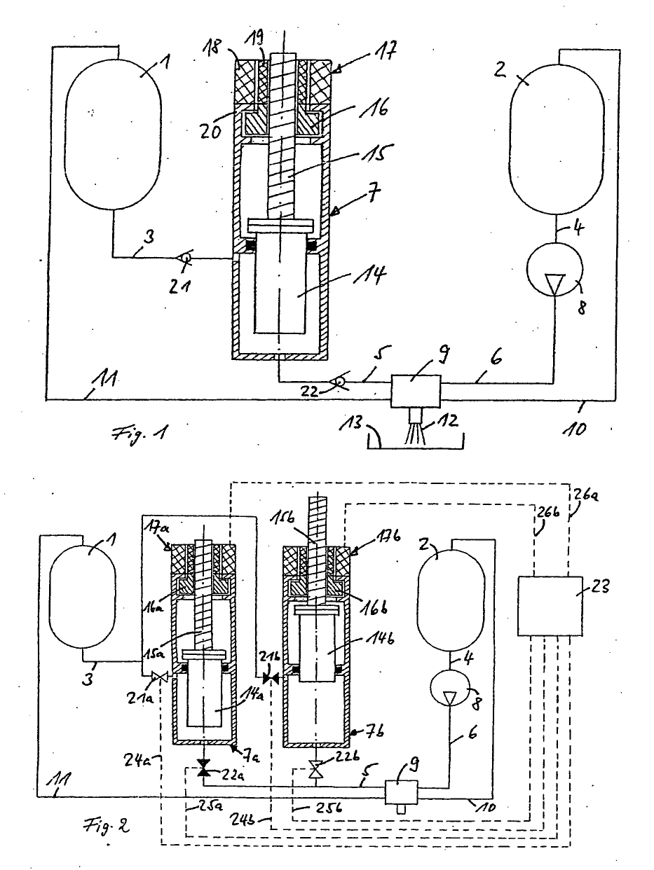

FIG. 1 shows, by way of example, the solution to the described problem, namely a diagram of an apparatus for processing conventionally liquid or pasty reactive components. In the illustrated apparatus, the reactive components are conveyed by means of dispensing units in an exact mixing ratio via suction and pressure lines from storage tanks to a mixer and mixed therein. The reactive mixture is then introduced into a mold or applied onto a substrate. At least one of the dispensing units is a piston dispensing unit and contains a dispensing piston and a spindle unit, i.e. a spindle with spindle nut assigned to the dispensing piston, this nut being driven by a torque motor.

A key feature of the apparatus according to the invention is the use of a torque drive for moving the spindle nut. To date, torque motor driven spindle and dispensing pistons have not been used in piston dispensing systems. Torque motors are primarily used as in-wheel motors for special vehicles. In these applications, the requirements for load-independent, uniform motion are comparatively slight compared with the requirements in dispensing systems. In particular, highly dynamic load changes over time intervals of from 0.01 to 1 second are insignificant in vehicle drive systems.

In tests with piston dispensing units driven by torque motors, very good compressional rigidity has now surprisingly been found, i.e. a constant dispensing piston speed even in the event of dynamic pressure fluctuations of the stated timing magnitude of 0.01 to 1 second. In this manner, technical prejudices have been overcome with regard to any anticipated sudden drop in the speed of the torque motor in the event of fluctuations in load.

Torque motors are direct drives, i.e. they require neither a transmission nor a toothed belt. Systems using torque motors are accordingly simple in design and thus also economic and low in cost.

Return lines may also be arranged between the mixing head and storage tanks. In this way, it is possible to cause the reactive components to recirculate for conditioning before the start of production, during pauses and before each shot.

An apparatus without return lines is, however, also possible, in particular if pot lives are very short or if one of the reactive components must be processed immediately after an optional premixing operation.

In a particularly preferred embodiment of the apparatus according to the invention, torque motors are used which have from 12 to 128, preferably from 16 to 64, most preferably from 16 to 32 poles. In this manner, it is possible to achieve a high level of variability in the desired speed ranges.

Correspondingly, the spindle units may operate in the working stroke at speeds of preferably from 10 to 730 and more preferably from 20 to 500 revolutions per minute.

The speed of the torque motor is also preferably controllable. As a consequence, both the output quantity and the mixing ratio of the reactive components to one another may be adjusted.

In another embodiment of this invention, the spindle of the at least one dispensing unit has a preferred pitch of from 4 to 40 mm and more preferably of from 6 to 30 mm.

The combination of low spindle speeds with small spindle pitches enables extreme positioning accuracy for the dispensing piston stroke. This is important in order to ensure precise functioning, i.e. precise suction and pressure strokes of the piston dispensing unit.

Pressures of from 5 to 500 bar, preferably of from 50 to 400 bar, most preferably of from 100 to 300 bar can be generated with the piston dispensing unit according to the invention.

FIGS. 2, 3 and 4 illustrate a particularly interesting variant of the apparatus of the present invention. If two such piston dispensing units (in each case containing a dispensing piston and a spindle unit, i.e. a spindle with spindle nut, assigned to the dispensing piston, with the nut being driven by a torque motor) are assigned to a reactive component, generally the reactive component containing filler, it is possible to produce a continuous dispensing stream. It is, however, important here to adjust the functions of these two piston dispensing units to one another. This is shown by way of example in FIG. 4.

In the steady-state phases (tₘ to tₙ₊₁ or tₘ₊₁ to tₙ₊₂ etc.), only one of the two piston dispensers is alternately dispensing. In the non-steady-state phases Δt, both piston dispensers are in operation.

For the same dispensing stream to be present during the steady-state phases of the two piston dispensers, the following condition must apply:
F₁·s₁·n_{D1}=F₂·s₂·n_{D2}

In other words, the product of dispensing piston area F, spindle pitch s and spindle speed n_{D} must be of identical magnitude for both piston dispensers during the pressure stroke. If the piston areas F and spindle pitches s are of identical magnitude for both piston dispensers, this condition can be simplified to: n_{D1}=n_{D2}.

In the non-steady-state phases Δt, the spindle speed of the piston metering pump last in operation, is reduced from the operating speed n_{D1} to zero:
n_{D1}→ñ_{D1}→o

Simultaneously, the spindle speed of the switched on piston dispenser is raised from zero to n_{D2}:
o→ñ_{D2}→n_{D2}

The following further condition applies to these non-steady-state phases Δt:
(F₁·s₁·n_{D1}+F₂·s₂·ñ_{D2})=F₁·s₁·n_{D1}=F₂·s₂·n_{D2}
in order to maintain the same constant dispensing stream in this phase too.

This term can also be simplified if the two dispensing piston areas F₁ and F₂ and the spindle pitches s₁ and s₂ of the two dispensing units are of identical magnitude:
(ñ_{D1}+ñ_{D2})=n_{D1}=n_{D2}

The following further condition must be complied with in order to ensure proper functioning of each of the two piston dispensers:

$$\vert {F}_{1} \cdot {S}_{1} {\int }_{{t}_{n}}^{{t}_{m + 1}} {n}_{D 1} ⅆ t \vert = \vert {F}_{1} \cdot {S}_{1} {\int }_{{t}_{m + 1}}^{{t}_{m + 2}} {n}_{S 1} ⅆ t \vert$$

Simplified, this may be written:

$$\vert {\int }_{{t}_{n}}^{{t}_{m + 1}} {n}_{D 1} ⅆ t \vert = \vert {\int }_{{t}_{m + 1}}^{{t}_{n + 2}} {n}_{S 1} ⅆ t \vert$$

The dispensed volume which has been expelled in the pressure stroke must be completely replaced in the subsequent suction stroke. This formal relation also shows that the spindle speed nₛ₁ in the suction stroke must be greater than the spindle speed n_{D1} in the pressure stroke:
nₛ₁>n_{D1}.

This is because the time interval (tₘ₊₁−tₙ) is greater than the time interval (tₙ₊₂−tₘ₊₁). The same applies to piston dispenser 2
nₛ₂>n_{D2}.

The apparatus according to the invention may be used for many purposes, but in particular for processing filled reactive components. Examples which may be mentioned are:
polyurethane reactive components,
epoxy resin reactive components,
melamine resin reactive components.

The invention will be described in greater detail in terms of the following Figures.

In the apparatus illustrated in FIG. 1, the reactive components are conveyed from storage tanks 1, 2 via suction lines 3, 4 and pressure lines 5, 6 by means of dispensing units 7, 8 to a mixing head 9, from where, in the recirculation phases, they are conveyed backed via return lines 10, 11 to the storage tanks 1, 2. In “shot” operation, the reactive components in the mixing head 9 are conveyed into the mixing chamber and the reactive mixture 12 formed therein is then discharged into the mold 13.

A fast-running, high pressure dispensing pump 8 acts as the dispensing unit for the unfilled component and a piston dispensing unit 7 acts as the dispensing unit for the filled component. The piston dispensing unit 7 consists of a dispensing piston 14, a spindle unit with spindle 15 and spindle nut 16 and a torque motor 17 as drive. The stator 18 of the torque motor 17 is connected to the casing 20 of the piston dispensing unit 7. The rotor 19 of the torque motor 17 is connected to the spindle nut 16. When the rotor 19 and spindle nut 16 are in rotation, the spindle 15 is moved upwards or downwards depending on the direction of rotation and so too is the dispensing piston 14.

Non-return valves 21, 22 are arranged in the suction line 3 and pressure line 5 assigned to the piston dispensing unit 7 in order to ensure in each case an unambiguous direction of flow in suction and pressure operation.

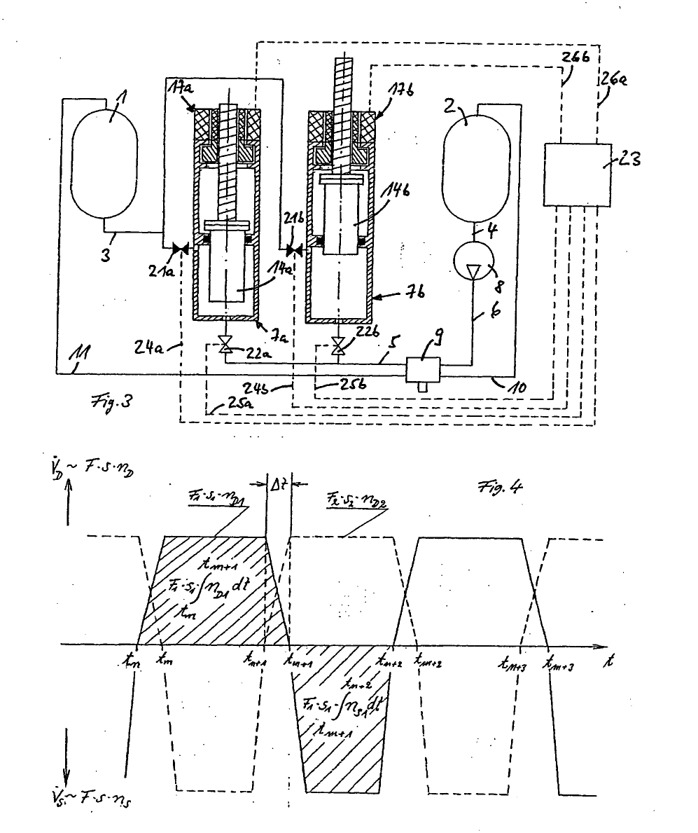

FIGS. 2 and 3 show in each case the same apparatus, a continuous device, but in two different operating states.

In the continuous device, two piston dispensing units 7a, 7b, which operate alternately, are assigned to the filled reactive component. Only in the transitional phases do the two piston dispensing units jointly produce the dispensing stream.

In this device, the reactive components are conveyed from storage tanks 1, 2 via suction lines 3, 4 and pressure lines 5, 6 to a mixing head 9 and, in the recirculation phases, via return lines 10, 11 back to the storage tanks 1, 2. For continuous operation, the unfilled component is again conveyed by a fast-running, high pressure dispensing pump 8 and the filled component by the two piston dispensing units 7a, 7b.

In FIG. 2, the first piston dispensing unit 7a is in suction operation, i.e. the suction valve 21a is open and the pressure valve 22a is closed. The dispensing piston 14a moves upwards, such that the reactive component is drawn in from the storage tank 1, the dispensing piston 14a being driven by the torque motor 17a via the spindle nut 16a and the spindle 14a. The second piston dispensing unit 7b is in pressure operation and produces the dispensing stream via the mixing head 9 by moving the dispensing piston 14b downwards. The suction valve 21b is closed and the pressure valve 22b is open. The dispensing piston 14b is driven by the torque motor 17b via the spindle nut 16b and the spindle 15b.

FIG. 3 shows a transitional phase. Both piston dispensing units 7a, 7b are in pressure operation, i.e. in dispensing operation. The suction valves 21a, 21b of both piston dispensing units 7a, 7b are closed and the pressure valves 22a, 22b of both dispensing units 7a, 7b are open.

In the first piston dispenser 7a, spindle speed is being reduced and brought down to zero. In the second piston dispenser 7b, spindle speed is being increased and raised to operating speed. Piston areas F₁ and F₂ and spindle pitches s₁ and s₂ of identical magnitude are selected for both piston dispensers in this example.

The sum of the two spindle speeds in this non-steady-state operating condition thus matches the operating speed of the spindles in the steady-state operating condition during pressure operation.

Control of the apparatus is shown in simplified form. The necessary pulse lines are shown only for the two piston dispensing units 7a, 7b. From the controller 23, pulse lines 24a, 24b run to suction valves 21a, 21b, and pulse lines 24a, 25b to the pressure valves 22a, 22b in order to be able to switch between the operating states: suction, pressure and the transitional phases. Pulse lines 26a, 26b furthermore lead from the controller 23 to the two torque motors 17a, 17b. These control the necessary spindle speeds and in each case predetermine the direction of rotation. The necessary timing functions are also predetermined by the controller 23. These are shown in detail in FIG. 4.

FIG. 4 shows for the continuous device described in FIG. 2 and FIG. 3 a graph of the dispensing streams \dot{V}_{D} as a function of time t and the suction streams \dot{V}_{S}, likewise as a function of time t. The continuous lines show the dispensing and suction streams of the first piston dispensing unit 7a and the broken lines correspondingly show those of the second piston dispensing unit 7b.

In the steady-state time phase tₘ to tₙ₊₁, the dispensing stream \dot{V}_{D} is produced by the first piston dispensing unit 7a. In the steady-state time phase tₘ₊₁ to tₙ₊₂, the dispensing stream \dot{V}_{D} is produced by the second piston dispensing unit 7b.

In the transitional phase Δt(=tₘ₊₁−tₙ₊₁) both piston dispensing units act together and jointly produce the dispensing stream \dot{V}_{D}. This is possible if the reduction in spindle speed of the first piston dispensing unit 7a is of the same magnitude as the rise in spindle speed of second piston dispensing unit 7b.

Because this alternating operation of the two piston dispensing units 7a, 7b continues constantly, a continuous dispensing stream is obtained \dot{V}_{D}.

The graph in FIG. 4 also shows the necessary suction functions because the piston dispensing unit which is not actually dispensing must be completely refilled in the interim. Since the suction phases are shorter than the dispensing phases, higher spindle speeds are accordingly necessary in the suction phase.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An apparatus for the production of articles from reactive components comprising:
a) one or more storage vessels for the reactive components,
b) a mixer for mixing the reactive components,
c) one or more dispensing units for the reactive components, with at least one dispensing unit comprising a piston dispensing unit comprising:
(1) a dispensing piston,
(2) a spindle unit comprising:
(i) a spindle and
(ii) a spindle nut which is driven by
(3) a torque motor,
d) means for conveying a given reactive component from its storage vessel to its dispensing unit, and
e) means for conveying each reactive component dispensed from its dispensing unit into the mixer.

2. The apparatus of claim 1 further comprising means for recirculating at least one reactive component between the mixer and its storage vessel.

3. The apparatus of claim 1 in which the torque motor has from 12 to 128 poles.

4. The apparatus of claim 1 in which the torque motor has from 16 to 64 poles.

5. The apparatus of claim 1 in which the torque motor has from 16 to 32 poles.

6. The apparatus of claim 1 in which the spindle unit can operate at speeds of from 10 revolutions min⁻¹ to 730 revolutions min⁻¹.

7. The apparatus of claim 1 in which the spindle unit can operate at speeds of from 20 revolutions min⁻¹ to 500 revolutions min⁻¹.

8. The apparatus of claim 1 in which the speed of the torque motor is controllable.

9. The apparatus of claim 1 in which the spindle (i) has a pitch of from 4 mm to 40 mm.

10. The apparatus of claim 1 in which the spindle (i) has a pitch of from 6 mm to 30 mm.

11. The apparatus of claim 1 in which the piston dispensing unit is capable of producing pressures of from 5 to 500 bar.

12. The apparatus of claim 1 in which the piston dispensing unit is capable of producing pressures of from 50 to 400 bar.

13. The apparatus of claim 1 in which the piston dispensing unit is capable of producing pressures of from 100 to 300 bar.

14. The apparatus of claim 1 in which two piston dispensing units are used to dispense at least one of the reactive components.

15. A process for the production of articles from reactive components in which the apparatus of claim 1 is used comprising:
a) dispensing the reactive components into the mixer,
b) mixing the reactive components present in the mixer to form a reaction mixture,
c) discharging the reaction mixture from the mixer into a mold or onto a substrate, and
d) allowing the reaction mixture to cure.

16. A process for the production of articles from reactive resins in the apparatus of claim 15, in which at least two piston dispensing units are employed.

17. The process of claim 16 in which the at least two piston dispensing units are operated in a manner such that a continuous stream of reactive mixture is discharged from the mixer comprising:
I. selecting a dispensing piston area, a spindle pitch and a spindle speed for the first piston dispensing unit in the pressure stroke such that the product of the selected dispensing area, spindle pitch and spindle speed will be equal to that of second piston dispensing area's dispensing piston area, spindle pitch and spindle speed product in the pressure stroke, and
II. selecting the sum of the products of dispensing piston area, spindle pitch and spindle speed for the two piston dispensing units in non-steady-state phases so that it will be equal to the sum of the products of dispensing piston area, spindle pitch and spindle speed for the two piston dispensing units in the steady-state phases.

18. The process of claim 17 in which the integral over speed as a function of time in the time interval during a pressure stroke for each of the piston dispensing units is equal to the integral over speed as a function of time in the time interval during each corresponding suction stroke.

19. The process of claim 15 in which at least one isocyanate component and at least one polyol component are used as the reactive components.

20. The process of claim 15 in which articles are produced from epoxy resin.

21. The process of claim 15 in which articles are produced from melamine resin.
